(19) United States
(12) Patent Application Publication
(10) Pub. No.: US 2022/0001391 A1
(43) Pub. Date: Jan. 6, 2022

(54) SYSTEM AND METHOD FOR RECOVERING DESIRED MATERIALS USING A BALL MILL OR ROD MILL

(71) Applicant: Thomas A. Valero, Atlanta, GA (US)

(72) Inventor: Thomas A. VALERIO, Atlanta, GA (US)

(21) Appl. No.: 17/478,408

(22) Filed: Sep. 17, 2021

Related U.S. Application Data
(63) Continuation of application No. PCT/US2020/023456, filed on Mar. 18, 2020.
(60) Provisional application No. 62/820,015, filed on Mar. 18, 2019.

(51) Int. Cl. B03B 9/06; C22B 1/00; B03B 9/04

(52) U.S. Cl. CPC B03B 9/061; B03B 2009/068; B03B 9/04; C22B 1/005

(57) ABSTRACT

A method for recovering metals from waste in which material is screened to leave a nonfibrous feedstock, the nonfeedstock is comminuted with a mill (e.g., a ball mill or rod) to liberate, flatten and separate the nonfibrous feedstock to obtain a mix of a metal fraction and residue, and the metal fraction and the residue are collected. There is a system employing the same to treat such materials.

### CROSS-REFERENCE TO RELATED APPLICATIONS

This application claims the benefit of priority to U.S. Provisional Patent Application No. 62/820,015, filed Mar. 18, 2019, the contents of this application is hereby incorporated by reference in their entirety.

### TECHNICAL FIELD

This application relates to systems for separating desired material from waste like automotive shredder residue (ASR), electronic waste, incinerator ash and the like. More specifically the invention talks about system for recovering of ferrous and nonferrous materials by reducing the size of the waste material to make the separation process easier.

### BACKGROUND

Millions of tons of municipal solid waste are produced every year. Waste management and utilization strategies are major concerns in many countries. Incineration is a common technique for treating waste, as it can reduce waste mass by 80% and volume by up to 90% and can allow recovery of energy from waste to generate electricity.

This application recognizes that systems using ball mills are in the prior art, e.g., WO Publication No. WO/2020/006007 entitled METHOD, PROCESS, AND SYSTEM OF USING A MILL TO SEPARATE METALS FROM FIBROUS FEEDSTOCK. The application discloses a method for recovering metals from waste in which material is roughly or coarsely separated to leave a fibrous feedstock. The feedstock is comminuted with a mill (e.g., a ball mill) to liberate and separate the fibrous feedstock to obtain a mix of a metal fraction and residue, and the metals fraction and the residue are collected.

To use the incinerator waste and reduce the environmental impact, treatment methods have been introduced and the waste has been classified and separated to promote recovery. There is always a need for improved methods for separating and classifying incinerator waste, including incinerator combined ash.

### SUMMARY

This application discloses a system and method for recovering of metals like ferrous and nonferrous to remove the problem of metal wastage. The invention also focuses on separating metals and nonmetals.

One aspect includes a method for recovering metals from a metal-based waste that includes separating any fibrous materials from the metal-based waste to leave a non-fibrous feedstock, comminuting the nonfibrous feedstock with a ball or rod mill to liberate, flattening, and separate the metals from the nonfibrous feedstock to obtain a mix of a metal fraction and residue, and separating the nonfibrous feedstock into residue and a metals fraction using density separation or mechanical separation; and collecting the metals fraction and collecting the residue. The segregating step can be a density separator. The method can include separating ferrous from the waste stream using a magnetic drum. The method can include setting apart the light material and heavy material by using a rougher. The method can reuse water by cleaning through a water treating assembly or circuit. The rougher can consist of a density separator and mechanical separator for setting apart the heavy and light material.

Another aspect is a system having a screening assembly to remove the fibrous material from a waste stream, a ball mill or rod mill, a mechanical separator, and the density separator. A rough concentrate assembly can be associated with the rougher for polishing of the heavy material present in the waste stream. A rough concentrate assembly may have a sand wheel, eddy current chamber and high pressure slurry pump for separation of non ferrous material from the waste stream. A density separator can connected to the ball mill for separation of materials by using specific gravity. An eddy current chamber for separating the nonferrous, a sand scrubber for detaching different type of the materials and a washing jet for removing sand from the materials may also be included with certain embodiments.

Another aspect includes a method or system for treating a waste stream that is a mixture of automotive shredder residue, electronic waste, incinerator ash and alike.

Yet another aspect is a system for recovering of metal from waste stream comprising, a feeder installed in the system to hold the waste stream, a star screen for size separation, a ball mill associated with the star screen to grind or flatten the waste stream, a falling velocity separator/density separator connected to the ball mill for sorting of organic and inorganic materials present in the waste stream, a wet magnetic drum coupled to the falling velocity separator/density separator to separate ferrous material from the waste stream, a rougher attached to the wet magnetic drum for sorting of the light and heavy materials and a water treatment assembly is connected to the rougher for reusing water that is utilized in the system.

While the invention has been described and shown with particular reference to the preferred embodiment, it will be apparent that variations might be possible that would fall within the scope of this application.

### BRIEF DESCRIPTION OF THE DRAWINGS

FIG. 1 illustrates a block diagram of the system for recovering metal from a waste stream;

FIG. 2 illustrates block diagram of the method for recovering metal from a waste stream; and

FIG. 3 shows an exemplary water recovery circuit that may be used with specific embodiments of this invention.

### DETAILED DESCRIPTION

This application discloses a system and method to recover metals from waste stream. Specific applications include methods and systems relate to the recovery of metals from any wet process or dry process. Such wet processes may include streams from, e.g., preconcentrators, water table concentrators, gold shaking tables such as produced by diester, Wilfery table concentrators, sink float tanks, sink float vessels, snail drums, barrel washers, wet processes using heavy media, DMS separators, hydro-cyclones, and other processes. Such dry processes, e.g., roughers such as an air aspirator Z box aspirator (broadly used in the EU for pre-concentrating auto mobile shredder residue. Other wet and dry processes are known to those with skill in the art.

This application invention also provides a way to separate ferrous and nonferrous materials. In some embodiments, the waste stream is automobile shredder residue. In other embodiments, the waste stream is ash or incinerator ash or combined bottom ash.

Generally, this disclosure relates to systems and methods for reclaiming, recovering, and obtaining desired materials from a waste stream having metals using a ball mill 105 or a rod mill at high capacity/low operational cost. The ball mill 105 or rod mill liberates embedded metals, and narrowly uniforms/flattens the shapes of the particles, so such materials can be further reclaimed with lower losses based on shape and density. In general, the waste stream can be automotive shredder residue (ASR), electronic waste, and incinerator ash. Water or other liquid can be used to separate portions of the material streams.

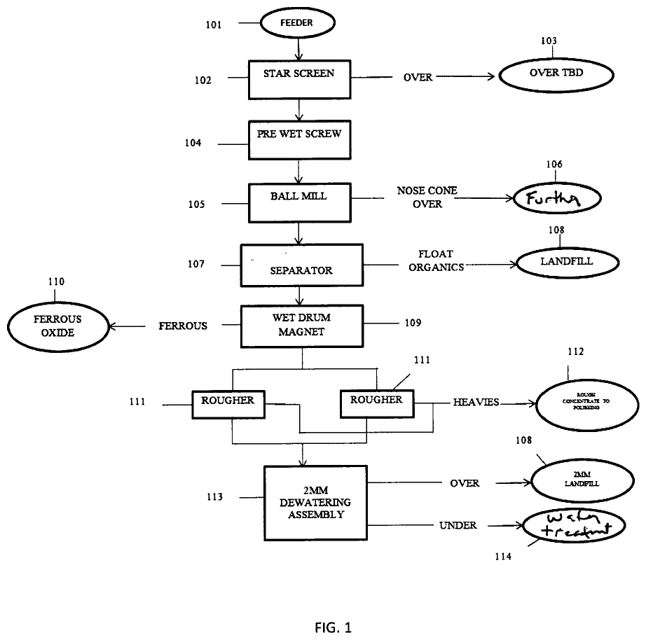

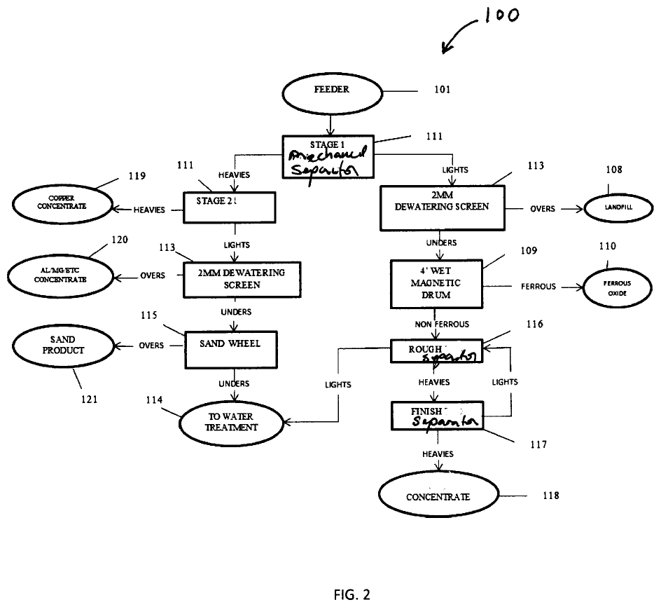

FIG. 1 illustrates an exemplary system 100 for separating incinerator of combined ash to obtain desired materials. A batch feeder 102 dispenses incinerator ash, ASR or other similar waste containing various sizes of materials into a screen 102 or other processing method to remove fibrous material (e.g., the process shown in FIG. 2). The screen 102 has a screen that allows materials about over 2 millimeters (mm) or less to pass through. Materials greater than lees about 2 mm can be removed from the system 100 for further manual and/or automatic processing. In this example, materials having a size over 2 mm can be sent to a size reducer/flatener 105, which comminutes the material. The size reducer 106 may be a ball mill (e.g., a wet-rubber ball mill), or like apparatus capable of reducing the size of the materials sent to the size reducer 105. Upon the materials being reduced and/or smashed, the material is sent to a magnet and/or is further processed. Crushing, pulverizing, flattening, and grinding lead to size reduction of the material or to “comminution”. The comminuted material may be conveyed to a size separator that fractionates the material by size to produce two or more sized waste streams (e.g., at least an over fraction and an under fraction). Comminution (e.g., shredding or grinding) may be carried out to improve the efficiency of size separation and density separation.

In one example, a screen 102 (e.g., star screen) can be attached to the feeder 101. The screen 102 aperture is a barrier made up of crisscross connection of thin wires. These wires are made of fiber. Due to fiber material the star screen 102 aperture becomes flexible and ductile in nature. The screen 102 may consist of tiny pours. These tiny pores may be of size less than 2 mm that may use to separate the minute materials from the waste stream that are smaller than 2 mm. Generally these particles are organic in nature. The particles that are larger in size than 2 mm may moves to a ball mill 105 for grinding the waste stream. In other examples, the screen sizes are greater than 4 mm, or 6 mm or 8 mm or 12 mm.

The feeder 101 dispenses the waste stream containing various sizes of materials into the initial screen (e.g., a star screen or any other screen). The initial screened material may run more efficiently through the process or system and protect the rod mill or ball mill 105. Materials in batch or continuous can be sent to a wet or dry ball mill 105 or rod mill. In certain examples, the ball or rod mill are wet. The ball mill 105 may be rubber lined. This process liberates the entangled and embedded metals and materials. In one example, the ball mill 105 or rod mill can flatten the particles, which renders them more buoyant for rising current systems. The metals, particularly malleable metals, from the ball mill 105 or rod mill are flattened.

From the ball mill 105 or rod mill, the material can be discretely sized or separated. For example, any device that can make multiple sized cuts can be used. For example, 0-2 mm, 2-6 mm, 6 mm-18 mm, 18 mm-54 mm, 54-100 mm are efficient cuts.

From the ball or rod mill 105, the material can eventually proceed to a density separator 107 (e.g., falling velocity separator and/or rising current separator and/or density separator 106 (e.g., a jig) or further screened, e.g., using a nose cone. In one example, the materials are separated, making a cut at approximately 1.6 Specific Gravity (SG). In one example, the organic material or non-metallic material may be removed and discarded and/or be used for solidification (e.g., absorbing wet or hazardous materials at landfill 108) and/or inorganic media.

In one example, basically the ball mill 105 is associated with the screen 102 at a size greater than 2 mm creates an unexpected result. Inner surface of the ball mill 105 is covered from rubber. The ball mill 105 is used for size reduction of the waste stream materials. The ball mill 105 also separates small and large size waste stream materials. Generally the ball mill 105 has a cylindrical shape that rotates around a horizontal axis. An internal cascading effect reduces the material to a fine powder. The ball mills 105 operate by fed from one end and discharged from another end.

The heavier materials with the metal or minerals are eventually processed by a magnetic separator (e.g., a wet magnet). Exemplary magnetic pulleys include low, medium and high intensity pulleys. At the magnetic pulley(s), ferrous 110 containing materials are removed from a product stream, leaving non-ferrous materials and minerals within the processing stream.

A density separator 106 can be connected or be operatively connected to the ball mill 105. The density separator 106 consist an inlet and out let for input and output of the waste stream materials for further processing. The density separator has the work to separate the materials by the help of specific gravity and a paddle wheel. The paddle wheel is attached to the center-top portion of the density separator. The paddle wheel rotates to generate disturbance in the water from that disturbance the separation of the heavy and light materials performed. The paddlewheel speed may vary at every process. The speed of the paddlewheel can be from 30 to 60 rpm.

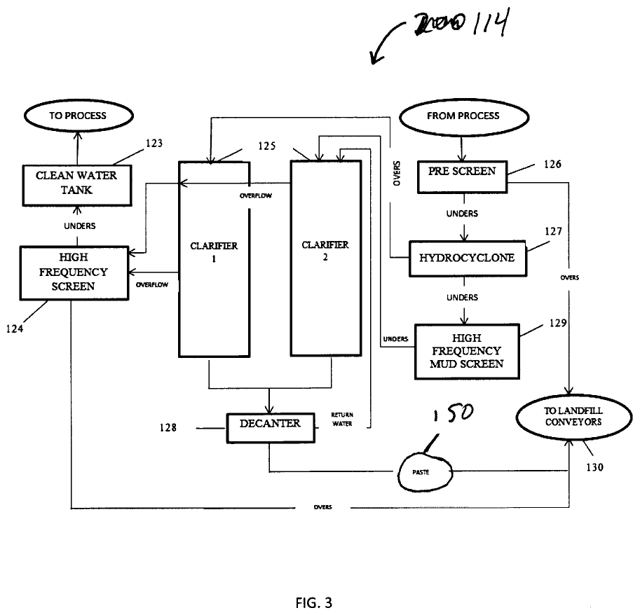

The material with the ferrous 110 removed is then processed through one or more rougher (e.g., jig or concentration tables, or wet or dry density separation). The heavies are further polished and the lights are further processed and screened. This cuts or divides mids from heavies. Mids can contain aggregate minerals and light metals (e.g., magnesium, aluminum). Part of the material may be processed accordingly to FIG. 3.

A falling velocity separator or a density separator 107 is connected to the ball mill 105. The falling velocity separator is for sorting of organic materials from waste stream that are left after the star screen 102. The falling velocity separator 107 is used to separate heavy and light particles from the waste stream. The falling velocity separator is approximately at 1.6. The waste stream of size 2 mm to 6 mm are separated by density of materials. The falling velocity separator 107 operates on specific gravity. The materials with lower than 1.6 are thrown inland fill. The land fill is the area where waste materials are disposed.

The specific gravity is known as relative density. This relative density is ratio of measured substance density and density of the reference. The falling velocity separator 107 operates on specific gravity about 1 to 1.6. The materials that are less than 1.6 are inorganic. These materials get separated from the waste stream, whereas the materials that are more than 1.6 are considered as ferrous 110 and nonferrous. The materials with high specific gravity moves to a wet magnetic drum 109 for separation of ferrous 110 materials from waste stream.

As shown in FIG. 2, a rougher is attached to the wet magnetic drum 109 for sorting of the waste stream. After passing the waste stream through the wet magnetic drum 109 the waste stream left with only nonferrous materials. These materials may contain the heavy and light materials that are separated by rougher 111. The rougher 111 can be a mechanical separator, density separator, or mechanical separator (e.g., separator by physical motion) 116, wherein a table 116 (e.g., WO2019222558—FLUIDIZED INERTIA TABLE). or mechanical separator can be used to separate material from waste stream. The mechanical separator 116 is used to separate light material from waste stream.

The density separator 116 consists of a rough density separator 116 that may separate light and heavy material from waste stream. The heavy material is further processed in a finish mechanical separator 117 (e.g., WO2018090039—METHOD AND SYSTEM FOR RECOVERING METAL USING A HELIX SEPARATOR. The finish density separator 117 is placed after the rough density separator 116 that is used for sorting of heavy material and light material is processed again in the rough density 116 or mechanical separator. The heavy materials may be of copper 119, aluminum 120, magnesium 120 or any other nonferrous material.

Number of dewatering screen 113 can be installed in the system. The screen 113 can be used to eliminate over sized material. The dewatering screen 113 can be similar to the star screen 102. The dewatering screen 113 pass the over sized material to landfill 108. After sorting the light and heavy material, the light material can be moved towards a rougher 111 concentrate assembly 112. The size of the pour in dewatering screen 113 is 2 mm. The material that is less than 2 mm may pass further and the material is greater than 2 mm is eliminated to landfill 108.

The rough concentrate assembly 112 can be associated with the rougher 111. The rough concentrate assembly 112 may further separate the light materials. The rough concentrate assembly 112 consists of a sand scrubber. The sand scrubber produce friction in the light materials to separate the inorganic materials 121 that may attached with the ferrous 110 and nonferrous materials present in the waste stream. The sand scrubber is basically a wide rotating wheel with multiple pockets for holding sand particles to scrub the light materials. After passing through the sand scrubber the waste stream materials split into ferrous 110 and nonferrous materials. The sand particles may stick to the ferrous 110 and nonferrous materials. To remove the sand particles, a high pressure slurry pump is used.

The high pressure slurry pump is a hydro cyclone that is used for eliminating sand particles from ferrous 110 and nonferrous materials. The high pressure slurry pump may consist of a dewatering screen 113 for draining the water for collecting in a return box. The water collected in the return box is filtered for reuse. An eddy current chamber is used for further separation of nonferrous from the waste stream.

The “mids” or mid sized materials may be processed using eddy current or sensor, which removes aluminum. The drops from the eddy current are aggregate and have commercial value as an aggregate product (e.g., asphalt or road bedding). In one example, a sand washer or sand wheel 115 can be used to dewater and further polish the material.

The eddy current is induced by changing in magnetic field and it flow in closed loops. The eddy current is perpendicular to a plane of the magnetic field. The eddy current is created upon moving a conductor through a magnetic field and due to this a change is experienced in intensity or direction of the magnetic field that may produce eddy current.

The heavies or heavy metals (e.g., copper, brass, zinc, lead, stainless streel, cadmium, etc.) can be further processed and graded.

As shown in FIG. 2, a batch feeder 101 dispenses materials to separate out to a first separation. Such separators may be wet concentrating tables. The heavies are concentrated and the lights are screened and dewatered. In one example, the light fraction may be further treated with a sand washer. A sand washer includes a sand wheel 115 or other sand separators. The sieve screen apertures in the sand washer allow it to function as a dewater device. One example of a sand separator in a device having a sand washing machine having parts including: wheel sand washer, high frequency dewatering screen 113, high pressure cyclone separator, cleaning tank, return box, high pressure slurry pump, motors, and associated pumps. The under scan be further processed as shown in FIG. 3, which allows for the collection of water and concentrating of waste material or market worthy materials.

FIG. 3 illustrates an exemplary system for separating a waste stream capable of reclaiming desired materials. The configuration of the system components showed in the figures results in the production or reclamation of media (e.g., inorganic materials under 200 mesh), sand and aggregates, and metals, and solidification materials for landfills 108.

The buoyancy is force that causes objects to float. The force exerted on an object that is partly or wholly immersed in a fluid. Buoyancy is cause by differences in pressure acting on opposite sides of an object immersed in a static fluid. It is also known as the buoyant force. Buoyancy is the phenomena due to buoyant force. An object is immersed in a liquid may experience an upward force that is known as buoyant force. An upward force exerted by the fluid that opposes a weight of an object immersed in the fluid. A pressure in the fluid column increases with depth. The pressure at the bottom of an object submerged in the fluid is greater than the force on the top. The difference in this pressure results in a net upward force on the object that defined as buoyancy.

A water treatment assembly 114, e.g., shown in FIG. 3 can be connected to the sorting unit. The a water treatment assembly 114 is used for the separation of remaining light materials and also use for reusing water that is utilized in the system. The water treatment assembly 114 is a water treatment module 114 with clean water store tank. The water treatment assembly 114 is used for the separation of heavy and light particles from the recovered water. The water treatment assembly 114 separates the materials by specific gravity. The heavy and light materials have same specific gravity in the recovered water as the specific gravity in the density separator 106. The materials that have high specific gravity are metals and low specific gravity materials are nonmetals. The water treatment assembly 114 is based on principle of a buoyancy force.

FIG. 3 shows that the water and lights may be treated accordingly through the use of screens, concentrators (e.g., hydro-cyclones 127), and clarifiers 125. One goal would be to recovery water, another would be reducing the amount of waste going to a landfill 108, and another would be to produce solidification, media and/or aggregate.

The clarifier 125 comprising, a water treatment assembly 114 for cleaning the water to reuse, wherein the water treatment assembly 114 further comprising a pre screen 126 for filtering the water, the overflow from the clarifier goes to the high frequency screen 124 a layer cleaning assembly connected to the clarifier 125 to set apart the heavy and light particle, a refining assembly mounted on the clarifier 125 for removing light particles to obtain clean water, wherein a hydro-cyclone 127 is attached to the refining assembly for cleaning the material, after passing through the hydro-cyclone 127, it goes to the high frequency mud screen 129 for eliminating impurities, a velocity separation assembly mounted on the clean water tank for extraction of the heavy particles and a decanter 128 connected to the velocity separation assembly for settling down heavy particles to reuse the clean water.

In one embodiment, the system and method incorporate the water circuit as closed loop. Generally, the paste 200 from the dewatering device or decantor 128 may be conveyed and used as part of media for the system or method, which essentially reduces further waste. The clarified water can be stored and reused as well. The method includes screening or fibers out of the material by using a screen less than 2 mm 101, pulverizing or flatting the material using a ball mill 105 or rod mill, and/or further processing the material at another step.

Although specific embodiments of the disclosure have been described above in detail, the description is merely for purposes of illustration. It is to be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of this application have been described, one of ordinary skill in the art will, upon considering the foregoing description, recognize that many modifications and variations of the invention may be employed. All such variations and modifications of the invention are intended to be covered by the foregoing description.

1. A method for recovering metals from a metal-based waste, comprising:
separating any fibrous materials from the metal-based waste to leave a non-fibrous feedstock;
comminuting the nonfibrous feedstock with a ball or rod mill to liberate and separate the metals from the nonfibrous feedstock to obtain a mix of a metal fraction and residue, and
separating the nonfibrous feedstock into residue and a metals fraction using density separation or mechanical separation; and
collecting the metals fraction and collecting the residue.

2. The method of claim 1, segregating the waste stream by using a density separator.

3. The method of claim 1, further comprising separating ferrous from the waste stream using magnetic drum.

4. The method of claim 1, further setting apart the light material and heavy material by using a rougher.

5. The method reusing water by cleaning through water treating assembly.

6. The method of claim 4, wherein the rougher consists of a density separator and mechanical separator for setting apart the heavy and light material.

7. A system comprising a screening assembly to remove the fibrous material from a waste stream, a ball mill or rod mill, a mechanical separator, and the density separator.

8. The system as claimed in claim 7, wherein a rough concentrate assembly associated with the rougher for polishing of the heavy material present in the waste stream.

9. The system as claimed in claim 8, further comprising a rough concentrate assembly further comprises of a sand wheel, eddy current chamber and high pressure slurry pump for separation of non ferrous material from waste stream.

10. The system as claimed in claim 1 or 7, wherein the waste stream is mixture of automotive shredder residue, electronic waste, incinerator ash and alike.

11. The system as claimed in claim 7, wherein a density separator is connected to the ball mill for separation of materials by using specific gravity.

12. The system as claimed in claim 11, wherein the rougher consists of eddy current chamber for separating the nonferrous, a sand scrubber for detaching different type of the materials and a washing jet for removing sand from the materials.

13. The system as claimed in claim 1, wherein plurality of dewatering screen is installed in the system for eliminating over sized material.
